(19) United States
(12) Patent Application Publication
(10) Pub. No.: US 2025/0185022 A1
(43) Pub. Date: Jun. 5, 2025

(54) MOBILE ORIGINATED DATA

(71) Applicant: QUALCOMM Incorporated, San Diego, CA (US)

(72) Inventors: Ayan SENGUPTA, San Diego, CA (US); Alberto RICO ALVARINO, San Diego, CA (US); Bharat SHRESTHA, San Diego, CA (US); Umesh PHUYAL, San Diego, CA (US)

(21) Appl. No.: 18/887,552

(22) Filed: Sep. 17, 2024

Related U.S. Application Data
(60) Provisional application No. 63/605,216, filed on Dec. 1, 2023.

(51) Int. Cl. H04W 72/232; H04W 72/21

(52) U.S. Cl. CPC H04W 72/232; H04W 72/21

(57) ABSTRACT

Methods, systems, and devices for wireless communication are described. A user equipment (UE) may transmit an uplink message that includes user data and an identifier associated with contention resolution and the UE. A UE may receive a downlink control information (DCI) message in response to the uplink message. In some examples, at least a portion of the DCI message may be scrambled according to a radio network temporary identifier (RNTI) associated with the UE. For example, the RNTI may be a first RNTI based on the identifier included in the uplink message, which may indicate that the DCI message is associated with contention resolution. In some cases, the RNTI may be a subset of the identifier, and a remaining subset of the identifier may be included in a payload of the DCI message. In some other examples, the RNTI may be a second RNTI associated with non-contention resolution procedures.

### CROSS REFERENCE

The present Application for Patent claims the benefit of U.S. Provisional Patent Application No. 63/605,216 by SENGUPTA et al., entitled “IMPROVEMENTS FOR MOBILE ORIGINATED DATA”, filed Dec. 1, 2023, which is assigned to the assignee hereof, and is expressly incorporated by reference herein.

### FIELD OF TECHNOLOGY

The following relates to wireless communication, including improvements for mobile originated data.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support improvements for mobile originated data. For example, the described techniques provide for a UE to transmit user data while operating in an idle mode. In some examples, the UE may transmit an uplink message that includes the user data and an identifier associated with contention resolution and the UE. A network entity may transmit a downlink control information (DCI) message in response to the uplink message. In some examples, at least a portion of the DCI message may be scrambled according to a radio network temporary identifier (RNTI) associated with the UE. For example, first RNTI may be a UE-specific RNTI based on the identifier included in the uplink message, which may indicate that the DCI message is associated with contention resolution. In some cases, the RNTI may be a subset of the identifier, and a remaining subset of the identifier may be included in a payload of the DCI message. In some other examples, the RNTI may be a second RNTI, such as a static RNTI, associated with purposes other than contention resolution. The UE may monitor for the DCI and attempt to decode the DCI according to the UE-specific RNTI and the second RNTI, and successful decoding may indicate a purpose of the DCI message to the UE. By transmitting a DCI message responsive to the uplink message, the network entity may experience reduced transmission overhead relative to other techniques, such as transmitting a downlink data message in response.

A method for wireless communication by a UE is described. The method may include transmitting, based on an idle mode of the UE, an uplink message that contains user data at the UE, the uplink message including, via a set of bits, a first identifier associated with the UE and receiving a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier.

A UE for wireless communication is described. The UE may include one or more memories storing processor executable code, and one or more processors coupled with the one or more memories. The one or more processors may individually or collectively operable to execute the code to cause the UE to transmit, based on an idle mode of the UE, an uplink message that contains user data at the UE, the uplink message including, via a set of bits, a first identifier associated with the UE and receive a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier.

Another UE for wireless communication is described. The UE may include means for transmitting, based on an idle mode of the UE, an uplink message that contains user data at the UE, the uplink message including, via a set of bits, a first identifier associated with the UE and means for receiving a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier.

A non-transitory computer-readable medium storing code for wireless communication is described. The code may include instructions executable by one or more processors to transmit, based on an idle mode of the UE, an uplink message that contains user data at the UE, the uplink message including, via a set of bits, a first identifier associated with the UE and receive a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier.

Some examples of the method, UEs, and non-transitory computer-readable medium described herein may further include operations, features, means, or instructions for decoding the downlink control information message based on the RNTI, where the RNTI may be the first RNTI, and where the first RNTI includes a first subset of the set of bits of the first identifier.

In some examples of the method, UEs, and non-transitory computer-readable medium described herein, a payload of the downlink control information message includes a second subset of the set of bits associated with the first identifier.

Some examples of the method, UEs, and non-transitory computer-readable medium described herein may further include operations, features, means, or instructions for resolving a contention between the UE and at least a second UE may be based on the first RNTI and the payload of the downlink control information message.

In some examples of the method, UEs, and non-transitory computer-readable medium described herein, the uplink message may be a contention-based shared preconfigured uplink resources (PUR) request message or an early data transmission (EDT) request message and the downlink control information message may be at least in part for contention resolution.

Some examples of the method, UEs, and non-transitory computer-readable medium described herein may further include operations, features, means, or instructions for decoding the downlink control information message based on the RNTI, where the RNTI may be a second RNTI of the set of multiple RNTIs different from the first RNTI.

In some examples of the method, UEs, and non-transitory computer-readable medium described herein, the second RNTI may be a static RNTI.

In some examples of the method, UEs, and non-transitory computer-readable medium described herein, the downlink control information message schedules an uplink data transmission, a downlink data message, indicates the UE to perform a random access procedure for transmission of the user data, or a combination thereof.

In some examples of the method, UEs, and non-transitory computer-readable medium described herein, the uplink data transmission may be scheduled for a retransmission, by the UE, of the user data, the downlink data message indicates the UE to switch to operating in a connected mode, or both.

Some examples of the method, UEs, and non-transitory computer-readable medium described herein may further include operations, features, means, or instructions for decoding the downlink control information message by evaluating, in a search space, a first scrambling hypothesis associated with the first identifier and by evaluating, in the search space, a second scrambling hypothesis associated with the second RNTI.

In some examples of the method, UEs, and non-transitory computer-readable medium described herein, when the uplink message may be a contention-based shared PUR request message, the second RNTI may be based on time and frequency resources associated with the uplink message, a multiplexing signature associated with the UE, a demodulation reference signal sequence, or a combination thereof.

In some examples of the method, UEs, and non-transitory computer-readable medium described herein, when the uplink message may be an EDT request message, the second RNTI may be a temporary cell radio network temporary identifier associated with the UE.

In some examples of the method, UEs, and non-transitory computer-readable medium described herein, a size of the downlink control information message may be different from a size of a second downlink control information message, where the downlink control information message is associated with a first downlink control information format that is different from a second downlink control information format associated with the second downlink control information message. In some cases, at least a portion of the second downlink control information message may be scrambled by an RNTI having a same value as the RNTI.

In some examples of the method, UEs, and non-transitory computer-readable medium described herein, a scrambling procedure associated with coded bits of the downlink control information message may be different from a scrambling procedure of a second downlink control information message and at least a portion of the second downlink control information message may be scrambled by an RNTI having a same value as the RNTI.

In some examples of the method, UEs, and non-transitory computer-readable medium described herein, the downlink control information message includes a flag bit that indicates whether the downlink control information message may be associated with a contention resolution procedure.

In some examples of the method, UEs, and non-transitory computer-readable medium described herein, the downlink control information message includes one or more additional flag bits that indicate whether the downlink control information message may be scheduling an uplink data message, whether the downlink control information message may be scheduling a downlink data message, or both.

Some examples of the method, UEs, and non-transitory computer-readable medium described herein may further include operations, features, means, or instructions for refraining from monitoring for additional downlink transmissions while operating in the idle mode after receiving the downlink control information message and monitoring for additional downlink transmissions based on transmitting a second uplink message indicating second user data.

Some examples of the method, UEs, and non-transitory computer-readable medium described herein may further include operations, features, means, or instructions for monitoring, after receiving the downlink control information message, for additional downlink transmissions during a first time period and entering a sleep period after the first time period.

Some examples of the method, UEs, and non-transitory computer-readable medium described herein may further include operations, features, means, or instructions for receiving a system information block message indicating a downlink control configuration, the downlink control configuration indicating at least one of a start occasion for a search space associated with the downlink control information message, a start offset for a search space associated with the downlink control information message, or a quantity of repetitions associated with the downlink control information message.

Some examples of the method, UEs, and non-transitory computer-readable medium described herein may further include operations, features, means, or instructions for receiving a system information block message indicating an uplink control configuration, the uplink control configuration indicating the UE to transmit an acknowledgement message in response to the downlink control information message or in response to a downlink data message scheduled by the downlink control information message.

Some examples of the method, UEs, and non-transitory computer-readable medium described herein may further include operations, features, means, or instructions for receiving a system information block message indicating a downlink data message configuration associated with a data message, where the downlink control information message schedules the data message.

Some examples of the method, UEs, and non-transitory computer-readable medium described herein may further include operations, features, means, or instructions for determining a quantity of repetitions for transmission of the uplink message based on a downlink signal strength, a transmit power limit associated with the UE, or both.

In some examples of the method, UEs, and non-transitory computer-readable medium described herein, determining the quantity of repetitions based on the downlink signal strength may include operations, features, means, or instructions for determining the quantity of repetitions for transmission of the uplink message based on the downlink signal strength satisfying one or more signal strength thresholds.

Some examples of the method, UEs, and non-transitory computer-readable medium described herein may further include operations, features, means, or instructions for selecting one or more resource for transmission of the uplink message from a set of resources associated with the uplink message based on determining the quantity of repetitions for transmission of the uplink message.

Some examples of the method, UEs, and non-transitory computer-readable medium described herein may further include operations, features, means, or instructions for receiving a system information block message indicating a configuration associated with the downlink control information message, where the configuration may be active for a first narrowband-Internet-of-Things carrier associated with the UE.

Some examples of the method, UEs, and non-transitory computer-readable medium described herein may further include operations, features, means, or instructions for receiving a group-common downlink control information message including an indication of a backoff period, where the uplink message may be transmitted via a time occasion selected from a set of time occasions in accordance with the backoff period.

In some examples of the method, UEs, and non-transitory computer-readable medium described herein, the indication of the backoff period includes an indication of a time period or an indication of a quantity of transmission occasions.

Some examples of the method, UEs, and non-transitory computer-readable medium described herein may further include operations, features, means, or instructions for receiving a configuration indicating a limit transport block size and selecting a transport block size from a set of candidate transport block sizes for transmission of the uplink message in accordance with the limit transport block size.

A method for wireless communication by a network entity is described. The method may include receiving, based on an idle mode of a UE, an uplink message that contains user data at the UE, the uplink message including, via a set of bits, a first identifier associated with the UE and transmitting a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier.

A network entity for wireless communication is described. The network entity may include one or more memories storing processor executable code, and one or more processors coupled with the one or more memories. The one or more processors may individually or collectively operable to execute the code to cause the network entity to receive, based on an idle mode of a UE, an uplink message that contains user data at the UE, the uplink message including, via a set of bits, a first identifier associated with the UE and transmit a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier.

Another network entity for wireless communication is described. The network entity may include means for receiving, based on an idle mode of a UE, an uplink message that contains user data at the UE, the uplink message including, via a set of bits, a first identifier associated with the UE and means for transmitting a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier.

A non-transitory computer-readable medium storing code for wireless communication is described. The code may include instructions executable by one or more processors to receive, based on an idle mode of a UE, an uplink message that contains user data at the UE, the uplink message including, via a set of bits, a first identifier associated with the UE and transmit a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier.

In some examples of the method, network entities, and non-transitory computer-readable medium described herein, the RNTI may be the first RNTI and the first RNTI includes a first subset of the set of bits of the first identifier.

In some examples of the method, network entities, and non-transitory computer-readable medium described herein, a payload of the downlink control information message includes a second subset of the set of bits associated with the first identifier.

Some examples of the method, network entities, and non-transitory computer-readable medium described herein may further include operations, features, means, or instructions for resolving a contention between the UE and at least a second UE may be based on the first RNTI and the payload of the downlink control information message.

In some examples of the method, network entities, and non-transitory computer-readable medium described herein, the uplink message may be a contention-based shared PUR request message or an EDT request message and the downlink control information message may be at least in part for contention resolution.

In some examples of the method, network entities, and non-transitory computer-readable medium described herein, the RNTI may be a second RNTI of the set of multiple RNTIs that is different from the first RNTI.

In some examples of the method, network entities, and non-transitory computer-readable medium described herein, the second RNTI may be a static RNTI.

In some examples of the method, network entities, and non-transitory computer-readable medium described herein, the downlink control information message schedules an uplink data transmission, a downlink data message, indicates the UE to perform a random access procedure for transmission of the user data, or a combination thereof.

In some examples of the method, network entities, and non-transitory computer-readable medium described herein, the uplink data transmission may be scheduled for a retransmission, by the UE, of the user data, the downlink data message indicates the UE to switch to operating in a connected mode, or both.

In some examples of the method, network entities, and non-transitory computer-readable medium described herein, when the uplink message may be a contention-based shared PUR request message, the second RNTI may be based on time and frequency resources associated with the uplink message, a multiplexing signature associated with the UE, a demodulation reference signal sequence, or a combination thereof.

In some examples of the method, network entities, and non-transitory computer-readable medium described herein, when the uplink message may be an EDT request message, the second RNTI may be a temporary cell radio network temporary identifier associated with the UE.

In some examples of the method, network entities, and non-transitory computer-readable medium described herein, a size of the downlink control information message may be different from a size of a second downlink control information message, where the downlink control information message is associated with a first downlink control information format that is different from a second downlink control information format associated with the second downlink control information message. In some cases, at least a portion of the second downlink control information message may be scrambled by an RNTI having a same value as the RNTI.

In some examples of the method, network entities, and non-transitory computer-readable medium described herein, a scrambling procedure associated with coded bits of the downlink control information message may be different from a scrambling procedure of a second downlink control information message and at least a portion of the second downlink control information message may be scrambled by an RNTI having a same value as the RNTI.

In some examples of the method, network entities, and non-transitory computer-readable medium described herein, the downlink control information message includes a flag bit that indicates whether the downlink control information message may be associated with a contention resolution procedure.

In some examples of the method, network entities, and non-transitory computer-readable medium described herein, the downlink control information message includes one or more additional flag bits that indicate whether the downlink control information message may be scheduling an uplink data message, whether the downlink control information message may be scheduling a downlink data message, or both.

Some examples of the method, network entities, and non-transitory computer-readable medium described herein may further include operations, features, means, or instructions for transmitting a system information block message indicating a downlink control configuration, the downlink control configuration indicating at least one of a start occasion for a search space associated with the downlink control information message, a start offset for a search space associated with the downlink control information message, or a quantity of repetitions associated with the downlink control information message.

Some examples of the method, network entities, and non-transitory computer-readable medium described herein may further include operations, features, means, or instructions for transmitting a system information block message indicating an uplink control configuration, the uplink control configuration indicating the UE to transmit an acknowledgement message in response to the downlink control information message or in response to a downlink data message scheduled by the downlink control information message.

Some examples of the method, network entities, and non-transitory computer-readable medium described herein may further include operations, features, means, or instructions for transmitting a system information block message indicating a downlink data message configuration associated with a data message, where the downlink control information message schedules the data message.

Some examples of the method, network entities, and non-transitory computer-readable medium described herein may further include operations, features, means, or instructions for transmitting a system information block message indicating a configuration associated with the downlink control information message, where the configuration may be active for a first narrowband-Internet-of-Things carrier associated with the UE.

Some examples of the method, network entities, and non-transitory computer-readable medium described herein may further include operations, features, means, or instructions for transmitting a group-common downlink control information message including an indication of a backoff period, where the uplink message may be transmitted via a time occasion selected from a set of time occasions in accordance with the backoff period.

In some examples of the method, network entities, and non-transitory computer-readable medium described herein, the indication of the backoff period includes an indication of a time period or an indication of a quantity of transmission occasions.

Some examples of the method, network entities, and non-transitory computer-readable medium described herein may further include operations, features, means, or instructions for transmitting a configuration indicating a limit transport block size, where the uplink message may be transmitted using a transport block size from a set of candidate transport block sizes in accordance with the limit transport block size.

### BRIEF DESCRIPTION OF THE DRAWINGS

FIG. 1 shows an example of a wireless communications system that supports improvements for mobile originated data in accordance with one or more aspects of the present disclosure.

FIG. 2 shows an example of a wireless communications system that supports improvements for mobile originated data in accordance with one or more aspects of the present disclosure.

FIG. 3 shows an example of a process flow that supports improvements for mobile originated data in accordance with one or more aspects of the present disclosure.

FIGS. 4 and 5 show block diagrams of devices that support improvements for mobile originated data in accordance with one or more aspects of the present disclosure.

FIG. 6 shows a block diagram of a communications manager that supports improvements for mobile originated data in accordance with one or more aspects of the present disclosure.

FIG. 7 shows a diagram of a system including a device that supports improvements for mobile originated data in accordance with one or more aspects of the present disclosure.

FIGS. 8 and 9 show block diagrams of devices that support improvements for mobile originated data in accordance with one or more aspects of the present disclosure.

FIG. 10 shows a block diagram of a communications manager that supports improvements for mobile originated data in accordance with one or more aspects of the present disclosure.

FIG. 11 shows a diagram of a system including a device that supports improvements for mobile originated data in accordance with one or more aspects of the present disclosure.

FIGS. 12 through 15 show flowcharts illustrating methods that support improvements for mobile originated data in accordance with one or more aspects of the present disclosure.

### DETAILED DESCRIPTION

In some systems, a UE may initiate an uplink transmission while operating an idle mode. In some cases, the UE may use EDT techniques, and the UE may include user data within an early data transmission request to a network entity. By including the user data in the early data transmission request, the UE may reduce a total quantity of messages transmitted to initiate the uplink transmission relative to initiating random access channel (RACH) procedures. In some examples, the network entity may transmit an acknowledgment message in response. The network entity may be managing communications with several UEs, however, and the network entity may incur significant overhead associated with transmitting the acknowledgment message. In some examples, to reduce this overhead, the UE may initiate the uplink transmission using PUR techniques, in which the UE may transmit the uplink data while in idle mode via uplink resources that were configured to the UE when the UE was previously in a connected mode. However, this may not allow the UE to transmit the uplink data if the UE was not previously configured with the uplink resources. As such, additional techniques for a UE to transmit data while in an idle mode may be desired.

In accordance with examples as described herein, a UE may transmit user data while in an idle mode using contention-based shared PUR procedures (e.g., RACH-less EDT procedures). In some examples, one or more UEs may be configured with a pool of resources for use on a contention basis to transmit uplink user data (e.g., mobile originated data). As these resources may be shared between multiple UEs, collisions may occur, and a network entity may perform contention resolution to resolve the collisions. In some examples, contention resolution may be performed by a network entity using a DCI message, which may significantly reduce overhead relative to using a downlink shared channel message. In some examples, as a payload for the DCI message may be limited, a portion of a contention resolution identifier (CR ID) may be indicated via a scrambling (e.g., cyclic redundancy check (CRC) scrambling) of the DCI message. For example, a subset of (e.g., least significant, most significant) bits of the CR ID may be used as an RNTI (e.g., a UE-specific RNTI) for scrambling the DCI message, and a remaining subset of bits of the CR ID may be included within the payload of the DCI message. In some cases, such as if the DCI message in response to the uplink user data is intended for purposes other than contention resolution, the DCI message may be scrambled using a different, second RNTI (e.g., a static RNTI, a non-UE specific RNTI). Accordingly, the network entity may transmit a DCI message in response to the uplink user data, which may reduce a transmission overhead for the network entity and provide downlink resource savings.

Aspects of the disclosure are initially described in the context of wireless communications systems. Aspects of the disclosure are additionally described in the context of process flows. Aspects of the disclosure are further illustrated by and described with reference to apparatus diagrams, system diagrams, and flowcharts that relate to improvements for mobile originated data.

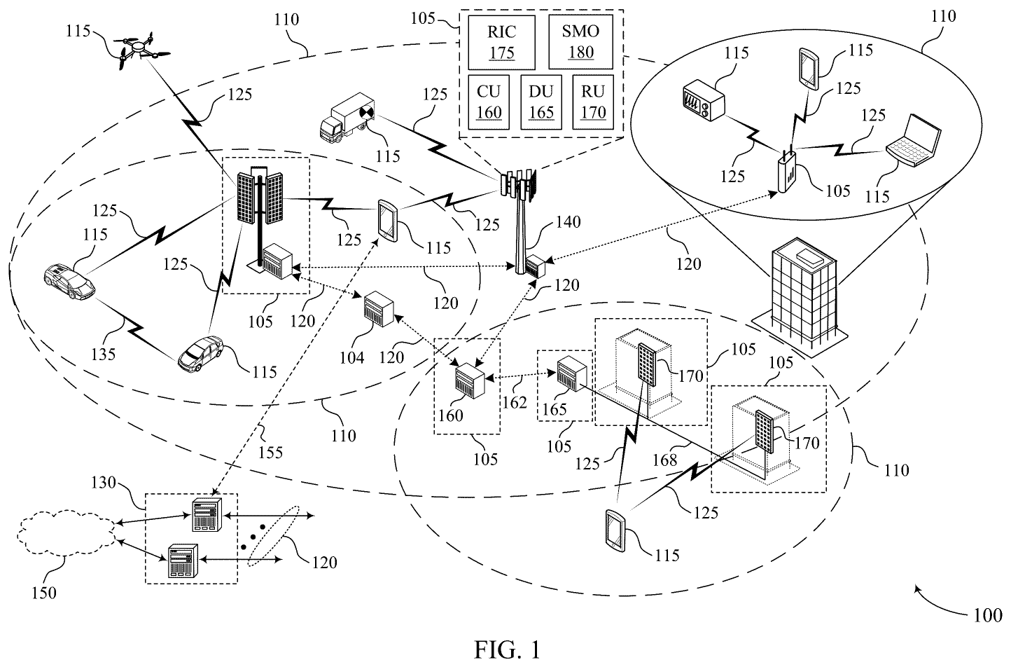

FIG. 1 shows an example of a wireless communications system 100 that supports improvements for mobile originated data in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support improvements for mobile originated data as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a CRC), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, for a UE 115 to perform a mobile originated data transmission, the UE 115 may use EDT techniques or PUR techniques to reduce latency and overhead (e.g., relative to using RACH techniques). For example, EDT techniques may reduce the quantity of steps (e.g., transmissions) performed (e.g., by the UE 115 and a network entity 105) for the UE 115 to send an uplink user data transmission from an idle mode (e.g., from five steps to three steps). Similarly, PUR techniques may further reduce the steps (e.g., transmissions) performed (e.g., to one step) by allowing the UE 115 to transmit an uplink data transmission from the idle mode in a resource that was previously configured to the UE 115. In some examples, EDT techniques allow for contention-based transmissions, in which the UE 115 may contend for resources with other UEs 115, while PUR techniques may allow for contention-free transmissions, as the UE 115 may transmit on resources dedicated to the UE 115 that may have been previously configured to the UE 115 while in a connected mode.

In some cases, as contention-free PUR techniques may involve resources configured to a UE 115 while in a connected mode, contention-free PUR techniques may not allow a UE 115 to transmit mobile originated data if the UE 115 has not previously been configured with resources (e.g., if the UE 115 has recently joined a network). EDT techniques, however, may incur significant overhead at a network entity 105. For example, the network entity 105 may be managing communications for several UEs 115. The network entity 105 may be configured to transmit an acknowledgment message (e.g., a per-UE Msg4 ACK) in response to the mobile originated data received from a respective UE 115 (e.g., via a Msg3), and the acknowledgment message may include a downlink data message (e.g., a physical downlink shared channel (PDSCH) message) and a downlink control message (e.g., a physical downlink control channel (PDCCH) message). The network entity 105 may be managing communications with various UEs 115, and the acknowledgment messages may therefore be overhead intensive in terms of downlink resource availability and utilization, especially in NB-IoT scenarios where bandwidth may be scarce. As such, different techniques for transmitting mobile originated data may be desired.

In accordance with examples as described herein, a UE 115 may transmit mobile originated data (e.g., user data) while in an idle mode using contention-based shared PUR procedures (e.g., RACH-less EDT procedures). Contention-based shared PUR procedures may allow the UE 115 to transmit uplink data via preconfigured resources. In contrast to contention-free PUR techniques, however, the resources may be shared between multiple UEs 115 and may not be necessarily dedicated to a particular UE 115. For example, one or more UEs 115 may be configured (e.g., in broadcast signaling, via system information blocks) with a pool of resources for use on a contention basis to transmit uplink user data (e.g., mobile originated data). The pool of resources may be configured to the one or more UEs 115 without the UEs 115 having previously operated in a connected mode, thereby allowing flexibility for transmitting the uplink resources.

As the resources for contention-based shared PUR procedures may be shared between multiple UEs 115, collisions may occur, and a network entity 105 may perform contention resolution to resolve the collisions. In some examples, contention resolution may be performed by a network entity using a DCI message, which may significantly reduce overhead relative to using a downlink shared channel (e.g., PDSCH) message. However, a payload for the DCI message may be limited relative to a payload for a downlink shared channel message, and the payload for the DCI message may not have a sufficient size to include an entirety of an identifier associated with the contention resolution (e.g., a CR ID). In some examples, a portion of the identifier may be indicated via a scrambling (e.g., CRC scrambling) of the DCI message. For example, a subset of (e.g., least significant) bits of the identifier may be used as an RNTI for scrambling the DCI message, and a remaining subset of bits of the identifier may be included within the payload of the DCI message.

In some cases, if the DCI message in response to the uplink user data is intended for purposes other than contention resolution, the DCI message may be scrambled using a different, second RNTI. For example, the DCI message may be used to initiate a retransmission of a corresponding uplink transmission by a UE 115, to transition the UE 115 from using one access technique to another (e.g., from contention-based shared PUR or EDT to using RACH techniques), or to indicate the UE 115 to transition to a connected mode. As such, the UE 115 may monitor for the DCI message in accordance with a scrambling hypothesis based on the first RNTI and the second RNTI, and the UE 115 may determine a purpose of the DCI message based on which scrambling hypothesis was successful. Accordingly, the network entity 105 and the UE 115 may operate using contention-based shared PUR techniques, thereby reducing overhead at the network entity 105.

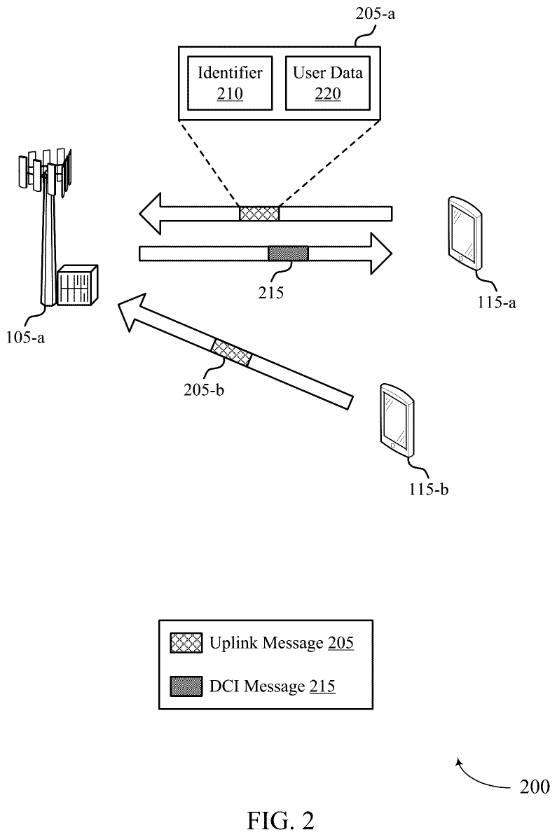

FIG. 2 shows an example of a wireless communications system 200 that supports improvements for mobile originated data in accordance with one or more aspects of the present disclosure. The wireless communications system 200 illustrates communications between a UE 115-a, a UE 115-b, and a network entity 105-a, which may be examples of corresponding devices as described herein, with reference to FIG. 1.

The UE 115-a and the UE 115-b may transmit user data 220 (e.g., mobile originated data) via uplink messages 205 using contention-based shared PUR techniques or RACH-less EDT techniques, which may support user data 220 transmissions based on (e.g., while the UE 115-a operates in) an idle mode. In some examples, such as for contention-based PUR, a resource pool may be defined (e.g., by the network entity 105-a) including resources for uplink transmission of user data 220 by one or more UEs 115, such as the UE 115-a and the UE 115-b. For example, the network entity 105-a may be associated with multiple resource pools, and each resource pool may define resources for one or more UEs 115, potentially using multiplexing techniques such as non-orthogonal multiple access (NOMA) techniques and orthogonal cover code (OCC) techniques. In some examples, each resource pool may be associated with a corresponding pool of demodulation reference signals (DMRS), and each DMRS of a pool may correspond to a respective resource of a resource pool to support a UE 115 transmitting uplink messages 205 via the resource. In some examples, the UE 115-a, the UE 115-b, or both, may receive an indication of a configured resource pool via a system information block (SIB) transmitted by the network entity 105-a.

In some examples, the network entity 105-a may transmit a message in response to the uplink messages 205. For example, the uplink messages 205 may be request messages (e.g., EDT request messages) for which the network entity 105-a may be configured to transmit a response. Additionally, or alternatively, if a multiplexing capacity of a resource in a resource pool is exceeded, for example, if too many UEs 115 are transmitting uplink messages 205 via the resource, then the network entity 105-a may detect a failure as the network entity 105-a may not be able to decode the multiple uplink messages 205. As such, the network entity 105-a may transmit a message to perform contention resolution procedures. In some examples, transmitting PDSCH message may be more downlink resource intensive than PDCCH messages (e.g., by a factor of 5). Accordingly, transmitting a response (e.g., for performing contention resolution) via a DCI message (e.g., a PDCCH message) may be desired to reduce downlink overhead at the network entity 105-a.

In accordance with examples as described herein, the network entity 105-a may perform contention resolution via a DCI message (e.g., a PDCCH message, using Layer 1-based mechanisms). In some examples, to transmit a DCI message 215 for contention resolution in response to an uplink message 205-a by the UE 115-a, the network entity 105-a may encode an identifier 210 associated with the contention resolution (e.g., a CR ID) within the DCI message 215. In some examples, the identifier may be a high level network identifier previously configured to the UE 115-a, and the UE 115-a may include the identifier 210 in the uplink message 205 (e.g., via the payload of the uplink message 205). In some cases, however, the identifier 210 (e.g., which may be 48 bits) may be too large to be encoded within a payload of the DCI message 215 (e.g., which may be 25 bits, in some implementations, to reduce overhead).

In some examples, to encode the identifier 210 within the DCI message 215, the network entity 105-a may embed part of the identifier 210 within a scrambling (e.g., a CRC scrambling) for the DCI message 215. For example, a first subset of bits of the identifier 210 (e.g., 16 least significant bits of the identifier 210) may form a first RNTI (e.g., a UE-specific RNTI). The network entity 105-a may scramble the DCI message 215 (e.g., scramble the CRC of the DCI message 215) using the first RNTI. The network entity 105-a may include a remaining second subset of bits of the identifier 210 within the payload of the DCI message 215. As such, the UE 115-a may monitor at least for the DCI message 215 scrambled using the first RNTI. Accordingly, the UE 115-a may receive the DCI message 215 indicating the identifier 210, which may indicate that the DCI message 215 is associated with contention resolution. The network entity 105-a may similarly transmit a DCI message 215 scrambled according to an RNTI associated with the UE 115-b in response to an uplink message 205-b.

In some examples, the network entity 105-a may transmit a DCI message 215 for different purposes in response to the uplink message 205-a from the UE 115-a. For example, the network entity 105-a may indicate, via the DCI message 215, for the UE 115-a to perform a retransmission of the user data 220 (e.g., a HARQ retransmission). In some cases, the DCI message 215 may schedule or indicate an uplink grant (e.g., a physical uplink shared channel (PUSCH) grant) for the retransmission. Additionally, or alternatively, the DCI message 215 may indicate the UE 115-a to change access techniques for transmission of the user data 220. For example, the DCI message 215 may indicate the UE 115-a to shift from using contention-based shared PUR (e.g., or RACH-less EDT, or another technique), to using a different access technique, such as a RACH procedure (e.g., a 4-step RACH procedure). Additionally, or alternatively, the DCI message 215 may indicate the UE 115-a to transition from the idle mode to a connected mode. In some cases, the DCI message 215 may schedule a downlink grant (e.g., a PDSCH) that may indicate a radio resource control (RRC) configuration (e.g., similar to an RRC configuration indicated via Msg4).

In some cases, however, if the DCI message 215 is used for one of these purposes, the identifier 210 associated with contention resolution may not be used for the DCI message 215. For example, if the uplink message 205 failed to be decoded by the network entity 105-a, the network entity 105-a may transmit the DCI message 215. However, the network entity 105-a may not have obtained the identifier 210 from the uplink message 205, for example. As such, to facilitate transmitting the DCI message 215 for non-contention resolution purposes, a second RNTI may be used.

For example, the network entity 105-a may scramble the DCI message 215 (e.g., scramble the CRC of the DCI message 215) with either the first RNTI or the second RNTI based on the purpose of the DCI message 215. For instance, for contention resolution, the DCI message 215 may be scrambled using the first RNTI that may be a subset of the identifier 210. For other purposes, such as for scheduling retransmissions of the user data 220, indicating the UE 115-a to change access techniques, transitioning (e.g., switching) the UE 115-a to the connected mode, or other purposes, the DCI message 215 may be scrambled with the second RNTI.

In some examples, the second RNTI may be based on an access technique being used by the UE 115-a. For example, for contention-based shared PUR, the second RNTI may be based on configured time resources, frequency resources, or both, being used for transmission of the uplink message 205. Additionally, or alternatively, the second RNTI may be based on multiplexing signatures used, such as an OCC for shared resources, or on a DMRS sequence associated with the resources. As such, the second RNTI may be independent from the identifier 210. In some examples, such as for EDT techniques (e.g., RACH-less EDT techniques), the second RNTI may be a temporary cell RNTI (TC-RNTI) associated with the UE 115-a, which may have been previously configured to the UE 115-a (e.g., by the network entity 105-a) and may be known to the UE 115-a and the network entity 105-a.

As the DCI message 215 may be scrambled by either the first RNTI or the second RNTI, and the DCI message 215 scrambled by either RNTI may be expected to arrive in a same search space without PDCCH candidate splitting for each RNTI, the UE 115-a may monitor for the DCI message 215 using two different scrambling hypotheses. For example, the UE 115-a may attempt to decode the DCI message 215 by evaluating a first scrambling hypothesis associated with the first RNTI. Additionally, or alternatively, the UE 115-a may attempt to decode the DCI message 215 by evaluating a second scrambling hypothesis associated with the second RNTI. In some examples, the UE 115-a may attempt to decode the DCI message 215 using one of the scrambling hypotheses, and if the decoding is not successful, the UE 115-a may attempt to decode the DCI message 215 using the other of the scrambling hypotheses. In some cases, if the UE 115-a is unsuccessful in decoding the DCI message 215, the DCI message 215 may be intended for a different UE 115 (e.g., the UE 115-b).

The UE 115-a may determine a purpose for the DCI message 215 based on which scrambling hypothesis is successful. For example, if the UE 115-a successfully decodes the DCI message 215 using the first RNTI, the UE 115-a may determine that the DCI message 215 is intended for contention resolution. Alternatively, if the UE 115-a successfully decodes the DCI message 215 using the second RNTI, the UE 115-a may determine that the DCI message 215 is intended for a different purpose than contention resolution, such as the purposes described herein. In some examples, the DCI message 215 may include a flag bit that indicates whether the DCI message 215 is associated with contention resolution or with other purposes. Additionally, or alternatively, the DCI message 215 may include one or more flag bits that indicates the purpose of the DCI message 215, for example, between scheduling a retransmission of the user data 220, scheduling a PDSCH to transition the UE 115-a to a connected mode, transitioning the UE 115-a to another access technique, contention resolution, or other purposes.

In some examples, it may be beneficial to mask the DCI message 215 from connected mode UEs 115 (e.g., legacy connected mode UEs 115), as the behavior indicated by the DCI message 215 may be specific to the idle mode UE 115-a. For example, the first RNTI or the second RNTI used to scramble the DCI message 215 may match (e.g., have a same value as) an RNTI, such as a cell RNTI (C-RNTI), associated with a different UE 115 (e.g., a legacy UE 115, a connected mode UE 115). As such, it would be beneficial for the different UE 115 to not be able to decode the DCI message 215. In some examples, to mask the DCI message 215 from connected mode UEs 115 (e.g., legacy UEs 115), the DCI message 215 may have a different size relative to other DCI messages having a different DCI format (e.g., legacy DCI messages, connected mode DCI messages). Additionally, or alternatively, coded bits (e.g., CRC bits) of the DCI message 215 may be scrambled using different scrambling techniques than those used for DCI messages (e.g., using DCI formats different than a DCI format for the DCI message 215) to the connected mode UEs 115. Accordingly, connected mode UEs 115 (e.g., legacy connected mode UEs 115) may not decode the DCI message 215, avoiding potential decoding confusion for the connected mode UEs 115.

In some examples, after receiving the DCI message 215 (e.g., the Layer 1 response message) from the network entity 105-a, the UE 115-a may be configured to cease monitoring for further downlink messages (e.g., while in the idle mode) until the UE 115-a has more user data 220 for transmission. Alternatively, the UE 115-a may be configured to monitor for downlink transmissions for an amount of time after receiving the DCI message 215. For example, the UE 115-a may be configured with an amount of time (e.g., in seconds, symbols, transmission occasions), after which, if no additional downlink messages are received, the UE 115-a may initiate sleep procedures.

In some cases, the UE 115-a may receive an SIB indicating a PDCCH configuration associated with the DCI message 215. For example, the network entity 105-a may transmit a message including an information element (e.g., a contention-PUR-PDCCH-Config-r19 information element) including one or more fields that indicate search space configurations (e.g., a starting slot or subframe, a start offset), a limit (e.g., maximum) quantity of PDCCH repetitions (e.g., for the DCI message 215), and other parameters (e.g., such as those defined in the information element PUR-MPDCCH-Config-r16 for contention-free PUR).

In some examples, the UE 115-a may also receive an SIB (e.g., or the same SIB) indicating physical uplink control channel (PUCCH) configuration. In some examples, the PUCCH configuration configure the UE 115-a to transmit an acknowledgment message (e.g., an acknowledgment (ACK) or a negative acknowledgment (NACK)) for the DCI message 215 or for a PDSCH scheduled by the DCI message 215. In some cases (e.g., in NB-IoT), the PDCCH-related configurations, the PUCCH-related configurations, or both, may be different based on a carrier. For example, the configurations may vary depending on if the UE 115-a is operating within an anchor carrier (e.g., anchor NB-IoT carrier) or a non-anchor carrier (e.g., a non-anchor NB-IoT carrier). In some examples, a configuration may be active for one or more carriers, such as NB-IoT carriers, while another configuration may be active for other carriers (e.g., other NB-IoT carriers).

Additionally, or alternatively, the UE 115-a may receive an SIB (e.g., the same SIB or a different SIB) that indicates a PDSCH configuration. The PDSCH configuration may configure the UE 115-a with one or more parameters for reception of a downlink data message (e.g., a PDSCH message), which may be scheduled by the DCI message 215. In some examples, the PDSCH configuration may indicate a limit (e.g., maximum) quantity of repetitions associated with the downlink data message, whether frequency hopping is enabled for the downlink data message, or other parameters.

In some examples, such as for contention-based shared PUR, there may be different coverage levels for the resources configured via an SIB. Each coverage level may be associated with a different quantity of repetitions for transmissions via the resources. In some cases, the UE 115-a may determine a coverage level (e.g., a quantity of repetitions) to use based on a downlink signal strength. For example, the UE 115-a may be configured with one or more reference signal received power (RSRP) thresholds (e.g., signal strength thresholds) for selecting a coverage level (e.g., a quantity of repetitions), and the RSRP threshold may have different values than RSRP thresholds not associated with contention-based shared PUR (e.g., RSRP thresholds for physical RACH procedures). As such, the UE 115-a may determine which coverage level to use based on whether a measured RSRP satisfies one or more RSRP thresholds (e.g., is at, above, below, or between one or more RSRP thresholds). Additionally, or alternatively, the UE 115-a may determine a coverage level to use based on a power class of the UE 115-a. For example, the UE 115-a may determine a coverage level based on a limit (e.g., maximum) transmit power of the UE 115-a, where a lower limit transmit power may be associated with a lower quantity of repetitions and a higher limit transmit power may be associated with a higher quantity of repetitions.

In some examples, such as for contention-based shared PUR, the network entity 105-a may transmit a group-common DCI message, which may be associated with a different RNTI, a different search space, or both, relative to the DCI message 215. The group-common DCI message may indicate a backoff indication for congestion control, and the UE 115-a and the UE 115-b may monitor for the group-common DCI message to obtain the backoff indication (e.g., prior to or after transmitting an uplink message 205). In some examples, the backoff indication may indicate a backoff period, which may be a physical time (e.g., in seconds), a quantity of transmission occasions, or another time-domain measure. The UE 115-a may receive the group-common DCI and randomly select a time resource in accordance with the backoff period (e.g., within the backoff period, after the backoff period) for transmitting the uplink message 205-a. In some cases, for example, transmitting UEs 115 may each randomly select time resources within the backoff period, thereby spreading out the transmissions, which may facilitate reception by the network entity 105-a. In some examples, for EDT techniques, backoff procedures may be provided by a random access report (RAR).

In some cases, the network entity 105-a may transmit a message indicating a limit (e.g., maximum) transport block size for which the network entity 105-a is to perform blind decoding for uplink messages 205. For example, the network entity 105-a may indicate a limit transport block size to the UE 115-a. In some examples, the UE 115-a may select a transport block size from a set of candidate transport block sizes in accordance with the limit transport block size and perform the transmission of the uplink message 205-a in accordance with the selected transport block size.

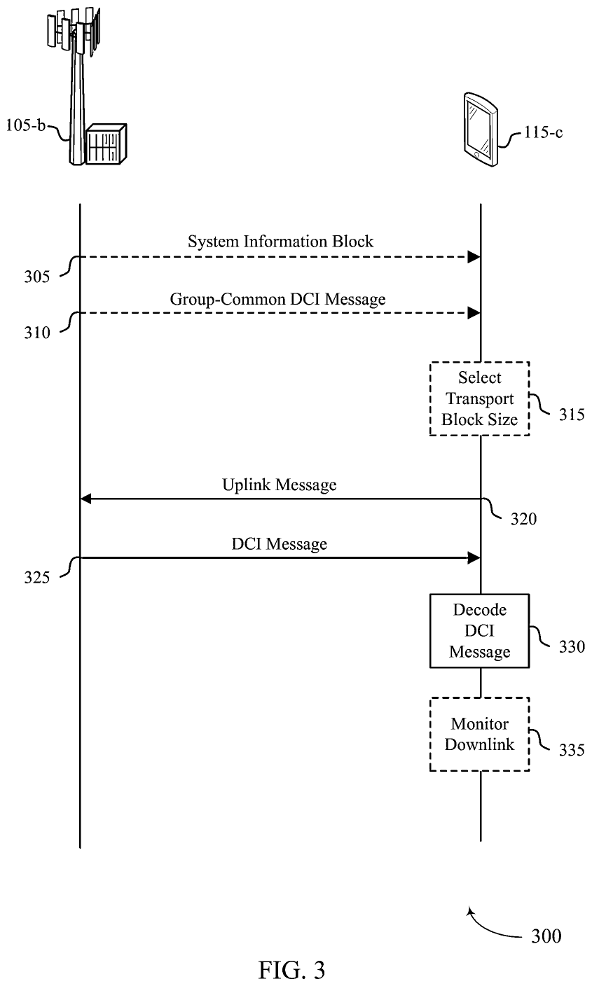

FIG. 3 shows an example of a process flow 300 that supports improvements for mobile originated data in accordance with one or more aspects of the present disclosure. The process flow 300 illustrates communications between a network entity 105-b and a UE 115-c, which may be examples of corresponding devices as described with reference to FIGS. 1 and 2. In some examples, some steps may be added or some steps may be omitted from the process flow 300. Additionally, or alternatively, some steps may be performed in a different order than shown.

At 305, the network entity 105-b may transmit an SIB that may indicate a downlink control configuration. In some examples, the downlink control configuration may indicate a start occasion and a start offset for a search space associated with a DCI message to be transmitted in response to an uplink message transmitted by the UE 115-c. Additionally, or alternatively, the downlink control configuration may indicate and a quantity of repetitions associated with transmission of the DCI message.

In some examples, the SIB (e.g., or a different SIB) may indicate an uplink control configuration. The uplink control configuration may indicate the UE 115-c to transmit an acknowledgment message in response to the DCI message or in response to a downlink data message scheduled by the DCI message.

At 310, the network entity 105-b may transmit a group-common DCI message to the UE 115-c and, in some examples, other UEs 115. The group-common DCI message may indicate a backoff period associated with uplink transmissions by the UE 115-c.

At 315, the UE 115-c may select a transport block size for transmission of the uplink message. In some examples, the UE 115-c may receive an indication of a limit transport block size from the network entity 105-b. The UE 115-c may select a transport block size from a set of candidate transport block sizes for transmission of the uplink message in accordance with the limit transport block size.

At 320, the UE 115-c may transmit the uplink message while operating in an idle mode. The uplink message may indicate user data at the UE 115-c, and the uplink message may include, via a first set of bits, an identifier associated with the UE 115-c. In some examples, the uplink message may be transmitted in accordance with the selected transport block size. In some cases, such as when the UE 115-c received an indication of a backoff period, the uplink message may be transmitted via a time occasion of a set of time occasions in accordance with the backoff period. In some examples, the uplink message may be a contention-based shared PUR request message or an EDT request message.

At 325, the network entity 105-b may transmit a DCI message responsive to the uplink message. In some examples, at least a portion (e.g., CRC bits) of the DCI message may be scrambled according to an RNTI of a plurality of RNTIs. In some examples, the plurality of RNTIs may include a first RNTI (e.g., a UE-specific RNTI) associated with contention resolution, and the first RNTI may be a first subset of the set of bits of the identifier.

At 330, the UE 115-c may decode the DCI message based on the RNTI. In some examples, the RNTI may be the first RNTI, which may be a plurality of least significant bits of the identifier. In some other examples, the RNTI may be a second RNTI of the plurality of RNTIs, such as a static RNTI, which may indicate that the DCI message is for non-contention resolution purposes. In some examples, to decode the DCI message, the UE 115-c may evaluate, in a search space, a first scrambling hypothesis associated with the first RNTI and, in the search space, a second scrambling hypothesis associated with the second RNTI.

At 335, the UE 115-c may monitor for additional downlink transmissions during a first time period after reception of the DCI message. In some examples, the UE 115-c may enter a sleep period after the first time period.

Accordingly, the network entity 105-b may communicate a response message to the uplink message via DCI (e.g., via Layer 1 signaling), which may significantly reduce overhead at the network entity 105-b relative to transmitting a response message via a PDSCH.

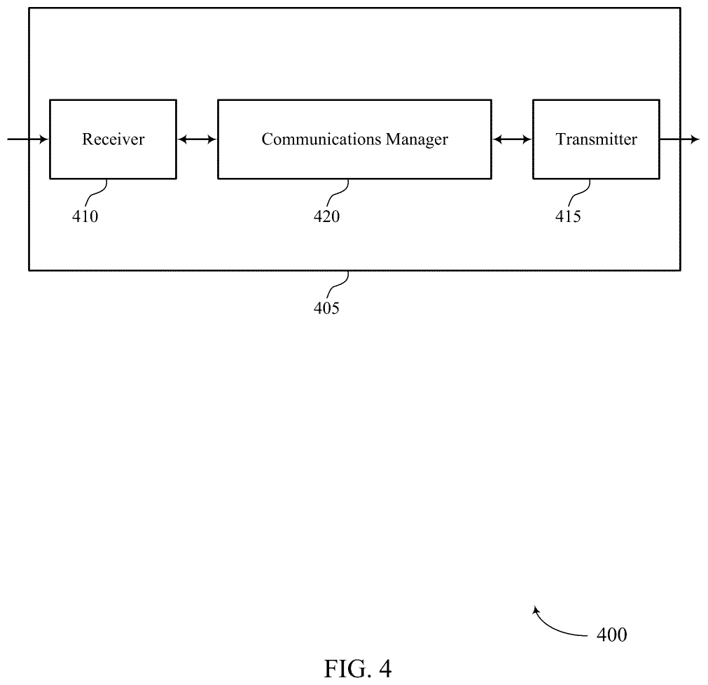

FIG. 4 shows a block diagram 400 of a device 405 that supports improvements for mobile originated data in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, and the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to improvements for mobile originated data). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to improvements for mobile originated data). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of improvements for mobile originated data as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor. If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication in accordance with examples as disclosed herein. For example, the communications manager 420 is capable of, configured to, or operable to support a means for transmitting, based on an idle mode of the UE, an uplink message that contains user data at the UE, the uplink message including, via a set of bits, a first identifier associated with the UE. The communications manager 420 is capable of, configured to, or operable to support a means for receiving a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reducing overhead relating to transmissions of mobile originated data and resolving contention arising from transmissions by multiple devices.

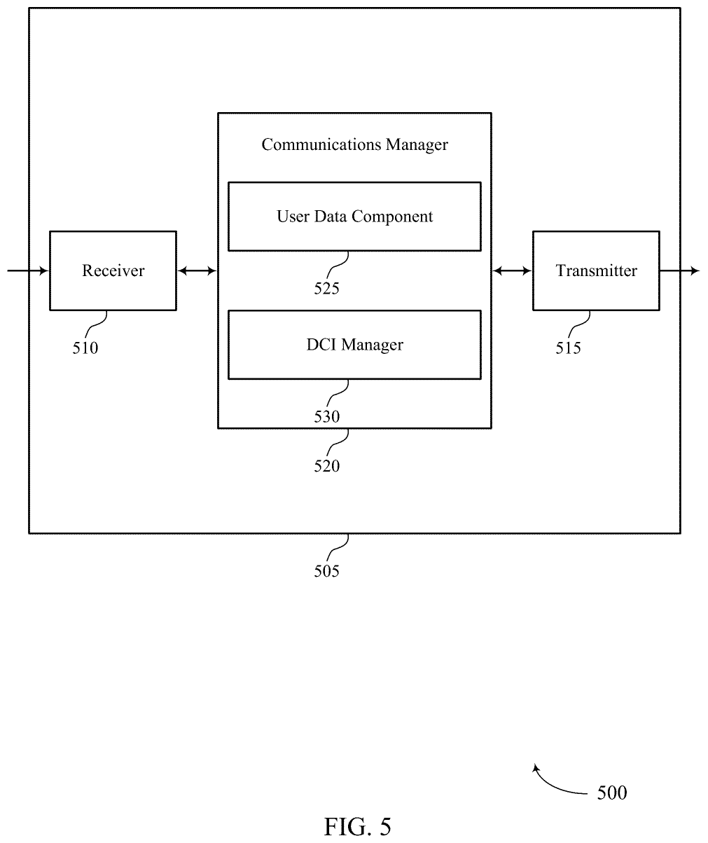

FIG. 5 shows a block diagram 500 of a device 505 that supports improvements for mobile originated data in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to improvements for mobile originated data). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to improvements for mobile originated data). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of improvements for mobile originated data as described herein. For example, the communications manager 520 may include a user data component 525 a DCI manager 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. The user data component 525 is capable of, configured to, or operable to support a means for transmitting, based on an idle mode of the UE, an uplink message that contains user data at the UE, the uplink message including, via a set of bits, a first identifier associated with the UE. The DCI manager 530 is capable of, configured to, or operable to support a means for receiving a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier.

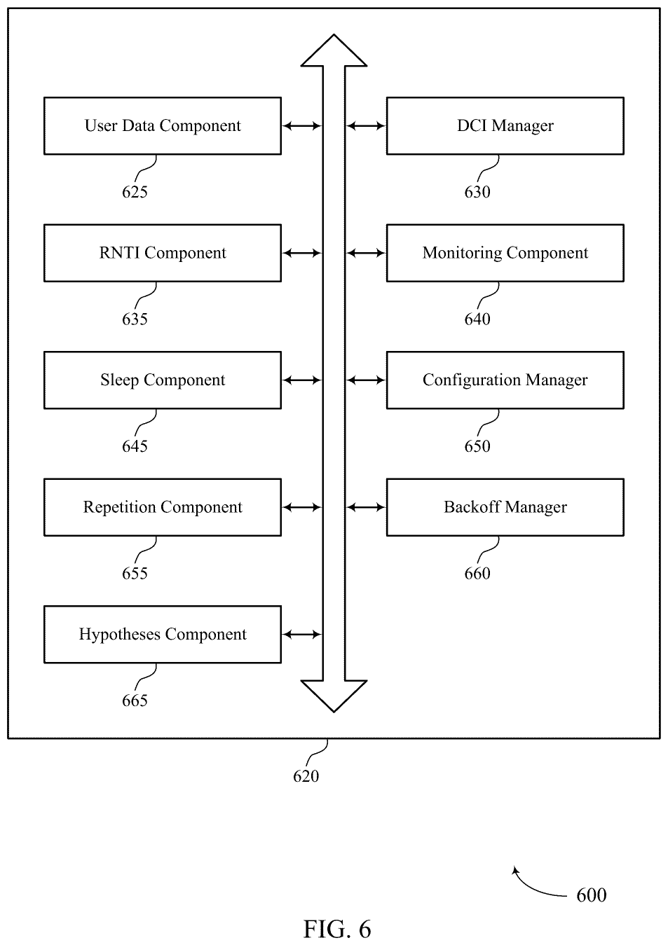

FIG. 6 shows a block diagram 600 of a communications manager 620 that supports improvements for mobile originated data in accordance with one or more aspects of the present disclosure. The communications manager 620 may be an example of aspects of a communications manager 420, a communications manager 520, or both, as described herein. The communications manager 620, or various components thereof, may be an example of means for performing various aspects of improvements for mobile originated data as described herein. For example, the communications manager 620 may include a user data component 625, a DCI manager 630, an RNTI component 635, a monitoring component 640, a sleep component 645, a configuration manager 650, a repetition component 655, a backoff manager 660, a hypotheses component 665, or any combination thereof. Each of these components, or components or subcomponents thereof (e.g., one or more processors, one or more memories), may communicate, directly or indirectly, with one another (e.g., via one or more buses).

The communications manager 620 may support wireless communication in accordance with examples as disclosed herein. The user data component 625 is capable of, configured to, or operable to support a means for transmitting, based on an idle mode of the UE, an uplink message that contains user data at the UE, the uplink message including, via a set of bits, a first identifier associated with the UE. The DCI manager 630 is capable of, configured to, or operable to support a means for receiving a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier.

In some examples, the RNTI component 635 is capable of, configured to, or operable to support a means for decoding the downlink control information message based on the RNTI, where the RNTI is the first RNTI, and where the first RNTI is a UE-specific RNTI that includes a first subset of the set of bits of the first identifier.

In some examples, a payload of the downlink control information message includes a second subset of the set of bits associated with the first identifier. In some examples, resolving a contention between the UE and at least a second UE is based on the first RNTI and the payload of the downlink control information message.

In some examples, the uplink message is a contention-based shared PUR request message or an EDT request message. In some examples, the downlink control information message is at least in part for contention resolution.

In some examples, the RNTI component 635 is capable of, configured to, or operable to support a means for decoding the downlink control information message based on the RNTI, where the RNTI is a second RNTI of the set of multiple RNTIs different from the first RNTI. In some examples, the second RNTI is a static RNTI.

In some examples, the downlink control information message schedules an uplink data transmission, a downlink data message, indicates the UE to perform a random access procedure for transmission of the user data, or a combination thereof. In some examples, the uplink data transmission is scheduled for a retransmission, by the UE, of the user data, the downlink data message indicates the UE to switch to operating in a connected mode, or both.

In some examples, the hypotheses component 665 is capable of, configured to, or operable to support a means for decoding the downlink control information message by evaluating, in a search space, a first scrambling hypothesis associated with the first identifier and by evaluating, in the search space, a second scrambling hypothesis associated with the second RNTI.

In some examples, when the uplink message is a contention-based shared PUR request message, the second RNTI is based on time and frequency resources associated with the uplink message, a multiplexing signature associated with the UE, a demodulation reference signal sequence, or a combination thereof. In some examples, when the uplink message is an EDT request message, the second RNTI is a temporary cell radio network temporary identifier associated with the UE.

In some examples, a size of the downlink control information message is different from a size of a second downlink control information message, where the downlink control information message is associated with a first downlink control information format that is different from a second downlink control information format associated with the second downlink control information message. In some examples, at least a portion of the second downlink control information message is scrambled by an RNTI having a same value as the RNTI.

In some examples, a scrambling procedure associated with coded bits of the downlink control information message is different from a scrambling procedure of a second downlink control information message, where the downlink control information message is associated with a first downlink control information format that is different from a second downlink control information format associated with the second downlink control information message. In some examples, at least a portion of the second downlink control information message is scrambled by an RNTI having a same value as the RNTI.

In some examples, the downlink control information message includes a flag bit that indicates whether the downlink control information message is associated with a contention resolution procedure.

In some examples, the downlink control information message includes one or more additional flag bits that indicate whether the downlink control information message is scheduling an uplink data message, whether the downlink control information message is scheduling a downlink data message, or both.

In some examples, the monitoring component 640 is capable of, configured to, or operable to support a means for refraining from monitoring for additional downlink transmissions while operating in the idle mode after receiving the downlink control information message. In some examples, the monitoring component 640 is capable of, configured to, or operable to support a means for monitoring for additional downlink transmissions based on transmitting a second uplink message indicating second user data.

In some examples, the monitoring component 640 is capable of, configured to, or operable to support a means for monitoring, after receiving the downlink control information message, for additional downlink transmissions during a first time period. In some examples, the sleep component 645 is capable of, configured to, or operable to support a means for entering a sleep period after the first time period.

In some examples, the configuration manager 650 is capable of, configured to, or operable to support a means for receiving a system information block message indicating a downlink control configuration, the downlink control configuration indicating at least one of a start occasion for a search space associated with the downlink control information message, a start offset for a search space associated with the downlink control information message, or a quantity of repetitions associated with the downlink control information message.

In some examples, the configuration manager 650 is capable of, configured to, or operable to support a means for receiving a system information block message indicating an uplink control configuration, the uplink control configuration indicating the UE to transmit an acknowledgment message in response to the downlink control information message or in response to a downlink data message scheduled by the downlink control information message.

In some examples, the configuration manager 650 is capable of, configured to, or operable to support a means for receiving a system information block message indicating a downlink data message configuration associated with a data message, where the downlink control information message schedules the data message.

In some examples, the repetition component 655 is capable of, configured to, or operable to support a means for determining a quantity of repetitions for transmission of the uplink message based on a downlink signal strength, a transmit power limit associated with the UE, or both.

In some examples, to support determining the quantity of repetitions based on the downlink signal strength, the repetition component 655 is capable of, configured to, or operable to support a means for determining the quantity of repetitions for transmission of the uplink message based on the downlink signal strength satisfying one or more signal strength thresholds.

In some examples, the repetition component 655 is capable of, configured to, or operable to support a means for selecting one or more resource for transmission of the uplink message from a set of resources associated with the uplink message based on determining the quantity of repetitions for transmission of the uplink message.

In some examples, the configuration manager 650 is capable of, configured to, or operable to support a means for receiving a system information block message indicating a configuration associated with the downlink control information message, where the configuration is active for a first NB-IoT carrier associated with the UE.

In some examples, the backoff manager 660 is capable of, configured to, or operable to support a means for receiving a group-common downlink control information message including an indication of a backoff period, where the uplink message is transmitted via a time occasion selected from a set of time occasions in accordance with the backoff period. In some examples, the indication of the backoff period includes an indication of a time period or an indication of a quantity of transmission occasions.

In some examples, the configuration manager 650 is capable of, configured to, or operable to support a means for receiving a configuration indicating a limit transport block size. In some examples, the configuration manager 650 is capable of, configured to, or operable to support a means for selecting a transport block size from a set of candidate transport block sizes for transmission of the uplink message in accordance with the limit transport block size.

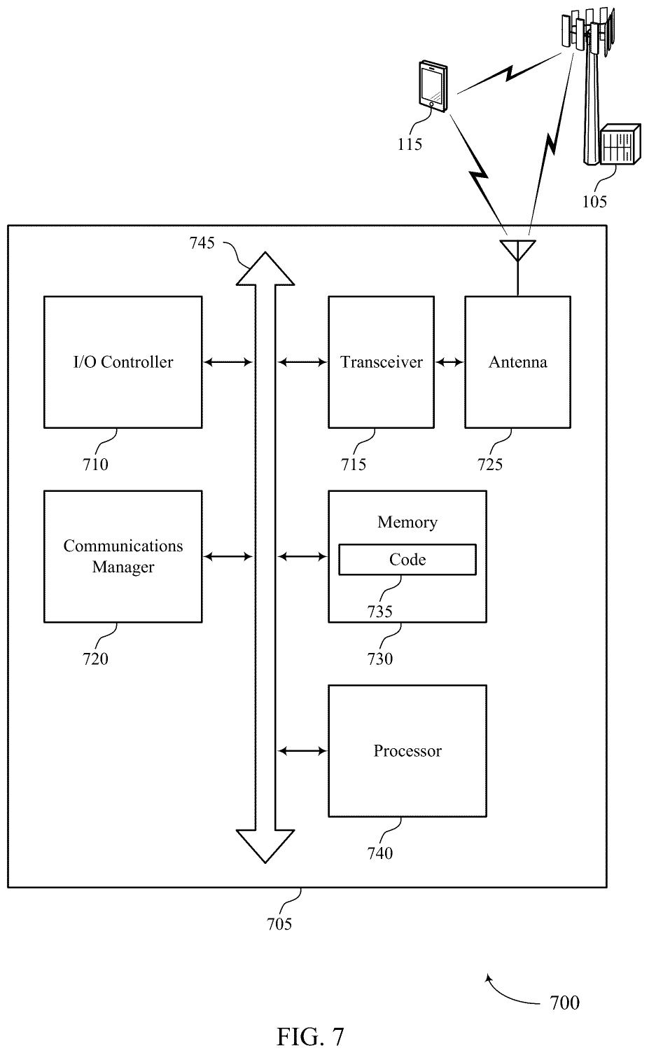

FIG. 7 shows a diagram of a system 700 including a device 705 that supports improvements for mobile originated data in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable (e.g., processor-executable) code 735 including instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may contain, among other things, a basic I/O system (BIOS) which may control basic hardware or software operation such as the interaction with peripheral components or devices.

The at least one processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting improvements for mobile originated data). For example, the device 705 or a component of the device 705 may include at least one processor 740 and at least one memory 730 coupled with or to the at least one processor 740, the at least one processor 740 and at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 730 or otherwise, to perform one or more of the functions described herein.

The communications manager 720 may support wireless communication in accordance with examples as disclosed herein. For example, the communications manager 720 is capable of, configured to, or operable to support a means for transmitting, based on an idle mode of the UE, an uplink message that contains user data at the UE, the uplink message including, via a set of bits, a first identifier associated with the UE. The communications manager 720 is capable of, configured to, or operable to support a means for receiving a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier.

By including or configuring the communications manager 720 in accordance with examples as described herein, the device 705 may support techniques for reducing overhead relating to transmissions of mobile originated data and resolving contention arising from transmissions by multiple devices, thereby leading to improved communications between devices and an enhanced user experience.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of improvements for mobile originated data as described herein, or the at least one processor 740 and the at least one memory 730 may be otherwise configured to, individually or collectively, perform or support such operations.

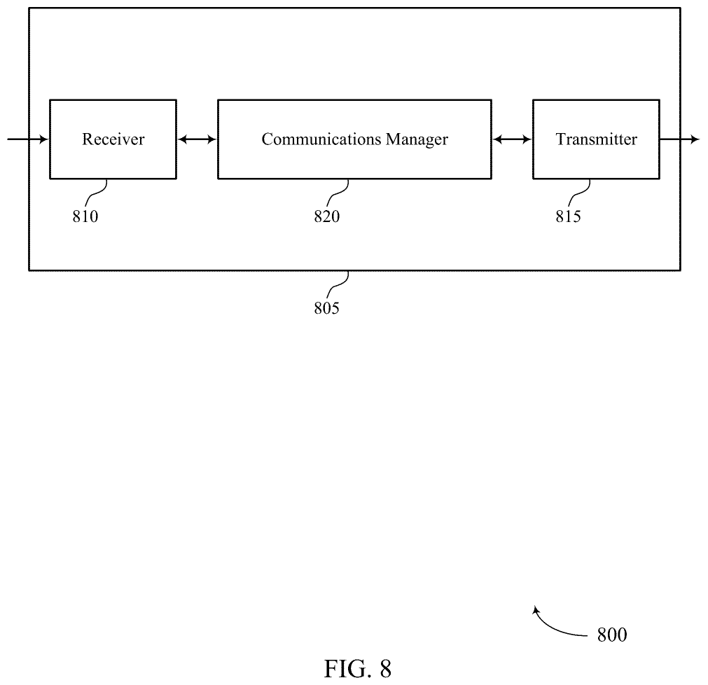

FIG. 8 shows a block diagram 800 of a device 805 that supports improvements for mobile originated data in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of improvements for mobile originated data as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor. If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. For example, the communications manager 820 is capable of, configured to, or operable to support a means for receiving, based on an idle mode of a UE, an uplink message that contains user data at the UE, the uplink message including, via a set of bits, a first identifier associated with the UE. The communications manager 820 is capable of, configured to, or operable to support a means for transmitting a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reducing overhead relating to transmissions of mobile originated data and resolving contention arising from transmissions by multiple devices, thereby leading to improved communications between devices and an enhanced user experience.

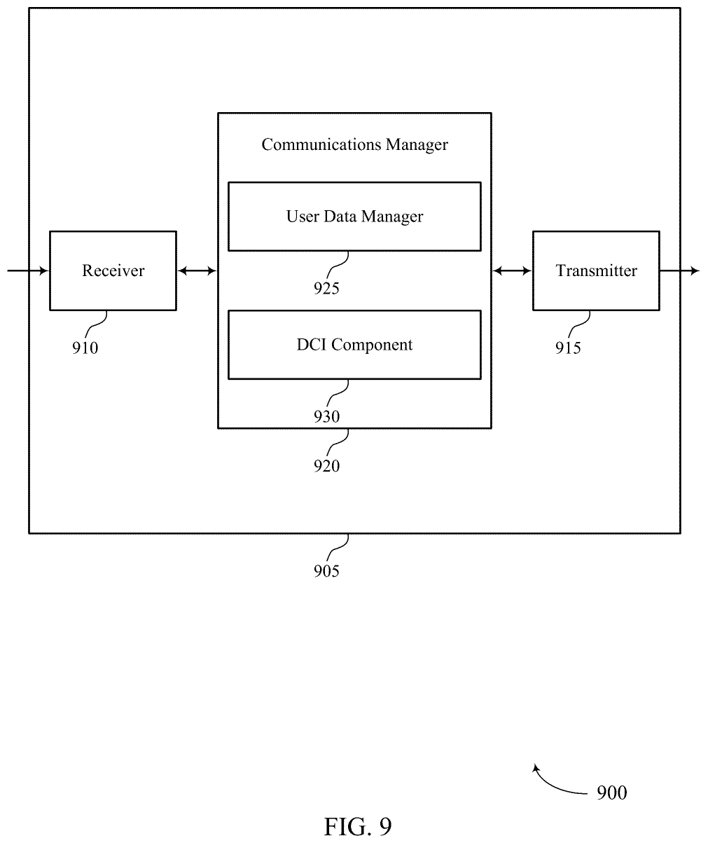

FIG. 9 shows a block diagram 900 of a device 905 that supports improvements for mobile originated data in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of improvements for mobile originated data as described herein. For example, the communications manager 920 may include a user data manager 925 a DCI component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. The user data manager 925 is capable of, configured to, or operable to support a means for receiving, based on an idle mode of a UE, an uplink message that contains user data at the UE, the uplink message including, via a set of bits, a first identifier associated with the UE. The DCI component 930 is capable of, configured to, or operable to support a means for transmitting a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier.

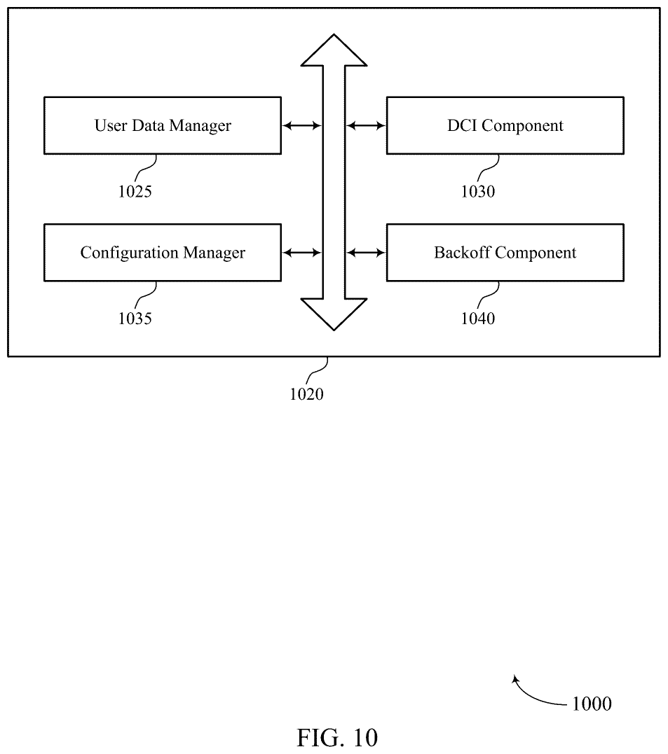

FIG. 10 shows a block diagram 1000 of a communications manager 1020 that supports improvements for mobile originated data in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of improvements for mobile originated data as described herein. For example, the communications manager 1020 may include a user data manager 1025, a DCI component 1030, a configuration manager 1035, a backoff component 1040, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication in accordance with examples as disclosed herein. The user data manager 1025 is capable of, configured to, or operable to support a means for receiving, based on an idle mode of a UE, an uplink message that contains user data at the UE, the uplink message including, via a set of bits, a first identifier associated with the UE. The DCI component 1030 is capable of, configured to, or operable to support a means for transmitting a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier.

In some examples, the RNTI is the first RNTI. In some examples, the first RNTI includes a first subset of the set of bits of the first identifier. In some examples, a payload of the downlink control information message includes a second subset of the set of bits associated with the first identifier. In some examples, resolving a contention between the UE and at least a second UE is based on the first RNTI and the payload of the downlink control information message.

In some examples, the uplink message is a contention-based shared PUR request message or an EDT request message. In some examples, the downlink control information message is at least in part for contention resolution. In some examples, the RNTI is a second RNTI of the set of multiple RNTIs. In some examples, the second RNTI is a static RNTI.

In some examples, the downlink control information message schedules an uplink data transmission, a downlink data message, indicates the UE to perform a random access procedure for transmission of the user data, or a combination thereof. In some examples, the uplink data transmission is scheduled for a retransmission, by the UE, of the user data, the downlink data message indicates the UE to switch to operating in a connected mode, or both.

In some examples, when the uplink message is a contention-based shared PUR request message, the second RNTI is based on time and frequency resources associated with the uplink message, a multiplexing signature associated with the UE, a demodulation reference signal sequence, or a combination thereof. In some examples, when the uplink message is an EDT request message, the second RNTI is a temporary cell radio network temporary identifier associated with the UE.

In some examples, a size of the downlink control information message is different from a size of a second downlink control information message where the downlink control information message is associated with a first downlink control information format that is different from a second downlink control information format associated with the second downlink control information message. In some examples, at least a portion of the second downlink control information message is scrambled by an RNTI having a same value as the RNTI.

In some examples, a scrambling procedure associated with coded bits of the downlink control information message is different from a scrambling procedure of a second downlink control information message, where the downlink control information message is associated with a first downlink control information format that is different from a second downlink control information format associated with the second downlink control information message. In some examples, at least a portion of the second downlink control information message is scrambled by an RNTI having a same value as the RNTI.

In some examples, the downlink control information message includes a flag bit that indicates whether the downlink control information message is associated with a contention resolution procedure.

In some examples, the downlink control information message includes one or more additional flag bits that indicate whether the downlink control information message is scheduling an uplink data message, whether the downlink control information message is scheduling a downlink data message, or both.

In some examples, the configuration manager 1035 is capable of, configured to, or operable to support a means for transmitting a system information block message indicating a downlink control configuration, the downlink control configuration indicating at least one of a start occasion for a search space associated with the downlink control information message, a start offset for a search space associated with the downlink control information message, or a quantity of repetitions associated with the downlink control information message.

In some examples, the configuration manager 1035 is capable of, configured to, or operable to support a means for transmitting a system information block message indicating an uplink control configuration, the uplink control configuration indicating the UE to transmit an acknowledgment message in response to the downlink control information message or in response to a downlink data message scheduled by the downlink control information message.

In some examples, the configuration manager 1035 is capable of, configured to, or operable to support a means for transmitting a system information block message indicating a downlink data message configuration associated with a data message, where the downlink control information message schedules the data message.

In some examples, the configuration manager 1035 is capable of, configured to, or operable to support a means for transmitting a system information block message indicating a configuration associated with the downlink control information message, where the configuration is active for a first NB-IoT carrier associated with the UE.

In some examples, the backoff component 1040 is capable of, configured to, or operable to support a means for transmitting a group-common downlink control information message including an indication of a backoff period, where the uplink message is transmitted via a time occasion selected from a set of time occasions in accordance with the backoff period.

In some examples, the indication of the backoff period includes an indication of a time period or an indication of a quantity of transmission occasions.

In some examples, the configuration manager 1035 is capable of, configured to, or operable to support a means for transmitting a configuration indicating a limit transport block size, where the uplink message is transmitted using a transport block size from a set of candidate transport block sizes in accordance with the limit transport block size.

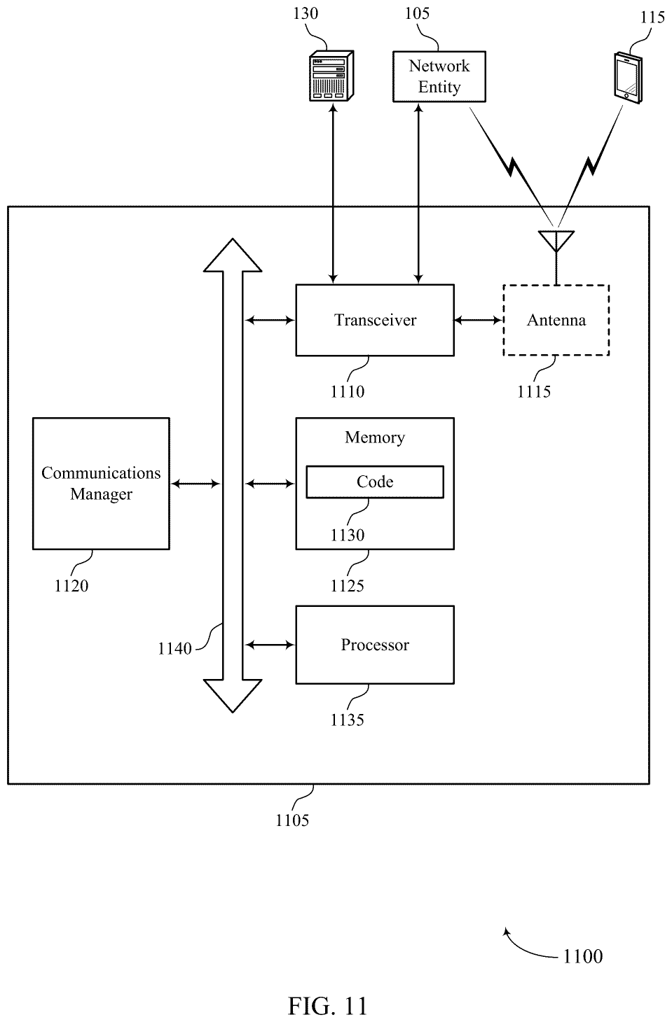

FIG. 11 shows a diagram of a system 1100 including a device 1105 that supports improvements for mobile originated data in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., a communication link 125, a backhaul communication link 120, a midhaul communication link 162, a fronthaul communication link 168).

The at least one memory 1125 may include RAM, ROM, or any combination thereof. The at least one memory 1125 may store computer-readable, computer-executable code 1130 including instructions that, when executed by one or more of the at least one processor 1135, cause the device 1105 to perform various functions described herein. The code 1130 may be stored in a non-transitory computer-readable (e.g., processor-readable, processor-executable) medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may contain, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting improvements for mobile originated data). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication in accordance with examples as disclosed herein. For example, the communications manager 1120 is capable of, configured to, or operable to support a means for receiving, based on an idle mode of a UE, an uplink message that contains user data at the UE, the uplink message including, via a set of bits, a first identifier associated with the UE. The communications manager 1120 is capable of, configured to, or operable to support a means for transmitting a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier.

By including or configuring the communications manager 1120 in accordance with examples as described herein, the device 1105 may support techniques for reducing overhead relating to transmissions of mobile originated data and resolving contention arising from transmissions by multiple devices, thereby leading to improved communications between devices and an enhanced user experience.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of improvements for mobile originated data as described herein, or the at least one processor 1135 and the at least one memory 1125 may be otherwise configured to, individually or collectively, perform or support such operations.

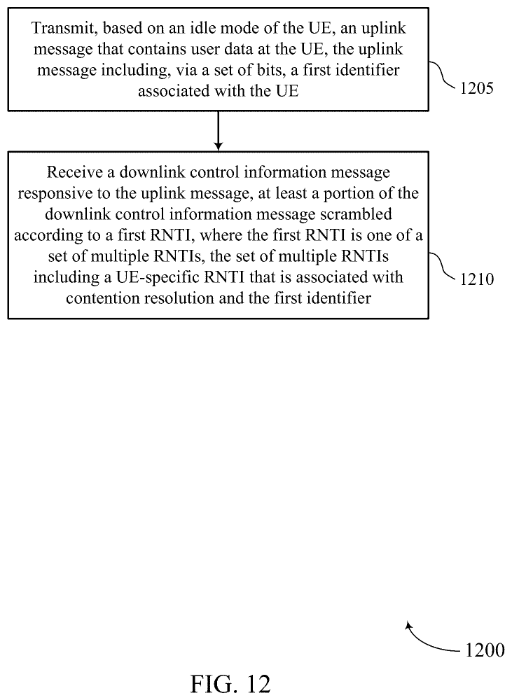

FIG. 12 shows a flowchart illustrating a method 1200 that supports improvements for mobile originated data in accordance with examples as described herein. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include transmitting, based on an idle mode of the UE, an uplink message that contains user data at the UE, the uplink message including, via a set of bits, a first identifier associated with the UE. The operations of block 1205 may be performed in accordance with examples as disclosed herein, such as operation 320 of FIG. 3. In some examples, aspects of the operations of 1205 may be performed by a user data component 625 as described with reference to FIG. 6.

At 1210, the method may include receiving a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier. The operations of block 1210 may be performed in accordance with examples as disclosed herein, such as operation 325 of FIG. 3. In some examples, aspects of the operations of 1210 may be performed by a DCI manager 630 as described with reference to FIG. 6.

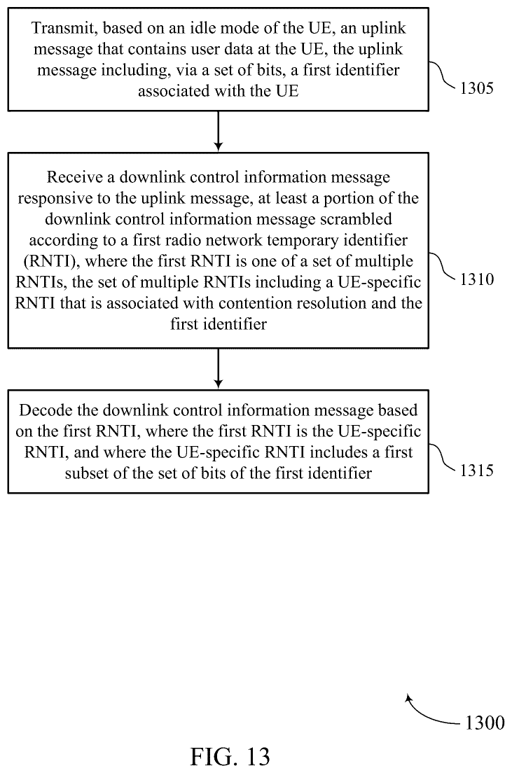

FIG. 13 shows a flowchart illustrating a method 1300 that supports improvements for mobile originated data in accordance with examples as described herein. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include transmitting, based on an idle mode of the UE, an uplink message that contains user data at the UE, the uplink message including, via a set of bits, a first identifier associated with the UE. The operations of block 1305 may be performed in accordance with examples as disclosed herein. In some examples, aspects of the operations of 1305 may be performed by a user data component 625 as described with reference to FIG. 6.

At 1310, the method may include receiving a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier. The operations of block 1310 may be performed in accordance with examples as disclosed herein. In some examples, aspects of the operations of 1310 may be performed by a DCI manager 630 as described with reference to FIG. 6.

At 1315, the method may include decoding the downlink control information message based on the RNTI, where the RNTI is the first RNTI, and where the first RNTI includes a first subset of the set of bits of the first identifier. The operations of block 1315 may be performed in accordance with examples as disclosed herein. In some examples, aspects of the operations of 1315 may be performed by an RNTI component 635 as described with reference to FIG. 6.

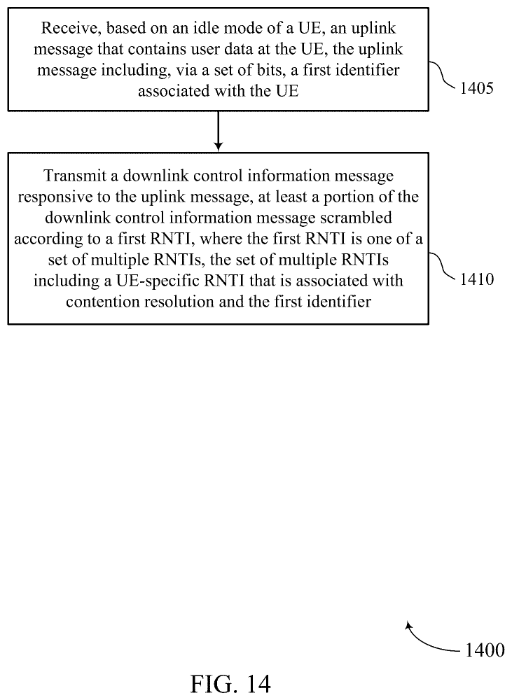

FIG. 14 shows a flowchart illustrating a method 1400 that supports improvements for mobile originated data in accordance with examples as described herein. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include receiving, based on an idle mode of a UE, an uplink message that contains user data at the UE, the uplink message including, via a set of bits, a first identifier associated with the UE. The operations of block 1405 may be performed in accordance with examples as disclosed herein. In some examples, aspects of the operations of 1405 may be performed by a user data manager 1025 as described with reference to FIG. 10.

At 1410, the method may include transmitting a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier. The operations of block 1410 may be performed in accordance with examples as disclosed herein. In some examples, aspects of the operations of 1410 may be performed by a DCI component 1030 as described with reference to FIG. 10.

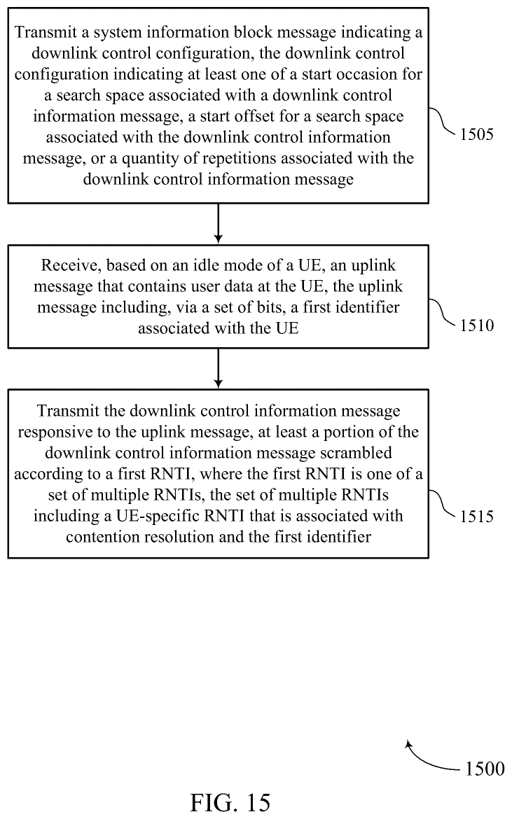

FIG. 15 shows a flowchart illustrating a method 1500 that supports improvements for mobile originated data in accordance with examples as descried herein. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include transmitting a system information block message indicating a downlink control configuration, the downlink control configuration indicating at least one of a start occasion for a search space associated with the downlink control information message, a start offset for a search space associated with the downlink control information message, or a quantity of repetitions associated with the downlink control information message. The operations of block 1505 may be performed in accordance with examples as disclosed herein. In some examples, aspects of the operations of 1505 may be performed by a configuration manager 1035 as described with reference to FIG. 10.

At 1510, the method may include receiving, based on an idle mode of a UE, an uplink message that contains user data at the UE, the uplink message including, via a set of bits, a first identifier associated with the UE. The operations of block 1510 may be performed in accordance with examples as disclosed herein. In some examples, aspects of the operations of 1510 may be performed by a user data manager 1025 as described with reference to FIG. 10.

At 1515, the method may include transmitting a downlink control information message responsive to the uplink message, at least a portion of the downlink control information message scrambled according to a RNTI, where the RNTI is one of a set of multiple RNTIs, the set of multiple RNTIs including a first RNTI that is associated with contention resolution and the first identifier. The operations of block 1515 may be performed in accordance with examples as disclosed herein. In some examples, aspects of the operations of 1515 may be performed by a DCI component 1030 as described with reference to FIG. 10.

The following provides an overview of aspects of the present disclosure:

Aspect 1: A method for wireless communication by a UE, comprising: transmitting, based at least in part on an idle mode of the UE, an uplink message that contains user data at the UE, the uplink message comprising, via a set of bits, a first identifier associated with the UE; and receiving a downlink control information message responsive to the uplink message, at least a portion of the downlink control information message scrambled according to a RNTI, wherein the RNTI is one of a plurality of RNTIs, the plurality of RNTIs including a first RNTI that is associated with contention resolution and the first identifier.

Aspect 2: The method of aspect 1, further comprising: decoding the downlink control information message based at least in part on the RNTI, wherein the RNTI is the first RNTI, and wherein the first RNTI is a UE-specific RNTI that comprises a first subset of the set of bits of the first identifier.

Aspect 3: The method of aspect 2, wherein a payload of the downlink control information message includes a second subset of the set of bits associated with the first identifier.

Aspect 4: The method of aspect 3, wherein resolving a contention between the UE and at least a second UE is based at least in part on the first RNTI and the payload of the downlink control information message.

Aspect 5: The method of any of aspects 2 through 4, wherein the uplink message is a contention-based shared PUR request message or an EDT request message, and the downlink control information message is at least in part for contention resolution.

Aspect 6: The method of aspects 1 or 5, further comprising: decoding the downlink control information message based at least in part on the RNTI, wherein the RNTI is a second RNTI of the plurality of RNTIs different from the first RNTI.

Aspect 7: The method of aspect 6, wherein the second RNTI is a static RNTI.

Aspect 8: The method of any of aspects 6 through 7, wherein the downlink control information message schedules an uplink data transmission, a downlink data message, indicates the UE to perform a random access procedure for transmission of the user data, or a combination thereof.

Aspect 9: The method of aspect 8, wherein the uplink data transmission is scheduled for a retransmission, by the UE, of the user data, the downlink data message indicates the UE to switch to operating in a connected mode, or both.

Aspect 10: The method of aspect 6, further comprising: decoding the downlink control information message by evaluating, in a search space, a first scrambling hypothesis associated with the first identifier and by evaluating, in the search space, a second scrambling hypothesis associated with the second RNTI.

Aspect 11: The method of any of aspects 6 through 10, wherein when the uplink message is a contention-based shared PUR request message, the second RNTI is based at least in part on time and frequency resources associated with the uplink message, a multiplexing signature associated with the UE, a demodulation reference signal sequence, or a combination thereof.

Aspect 12: The method of any of aspects 6 through 11, wherein when the uplink message is an EDT request message, the second RNTI is a temporary cell radio network temporary identifier associated with the UE.

Aspect 13: The method of any of aspects 1 through 12, wherein a size of the downlink control information message is different from a size of a second downlink control information message, where the downlink control information message is associated with a first downlink control information format that is different from a second downlink control information format associated with the second downlink control information message. RNTI

Aspect 14: The method of any of aspects 1 through 13, wherein a scrambling procedure associated with coded bits of the downlink control information message is different from a scrambling procedure of a second downlink control information message, where the downlink control information message is associated with a first downlink control information format that is different from a second downlink control information format associated with the second downlink control information message. RNTI

Aspect 15: The method of any of aspects 1 through 14, wherein the downlink control information message comprises a flag bit that indicates whether the downlink control information message is associated with a contention resolution procedure.

Aspect 16: The method of aspect 15, wherein the downlink control information message comprises one or more additional flag bits that indicate whether the downlink control information message is scheduling an uplink data message, whether the downlink control information message is scheduling a downlink data message, or both.

Aspect 17: The method of any of aspects 1 through 16, further comprising: refraining from monitoring for additional downlink transmissions while operating in the idle mode after receiving the downlink control information message; and monitoring for additional downlink transmissions based at least in part on transmitting a second uplink message indicating second user data.

Aspect 18: The method of any of aspects 1 through 16, further comprising: monitoring, after receiving the downlink control information message, for additional downlink transmissions during a first time period; and entering a sleep period after the first time period.

Aspect 19: The method of any of aspects 1 through 18, further comprising: receiving a system information block message indicating a downlink control configuration, the downlink control configuration indicating at least one of a start occasion for a search space associated with the downlink control information message, a start offset for a search space associated with the downlink control information message, or a quantity of repetitions associated with the downlink control information message.

Aspect 20: The method of any of aspects 1 through 19, further comprising: receiving a system information block message indicating an uplink control configuration, the uplink control configuration indicating the UE to transmit an acknowledgement message in response to the downlink control information message or in response to a downlink data message scheduled by the downlink control information message.

Aspect 21: The method of any of aspects 1 through 20, further comprising: receiving a system information block message indicating a downlink data message configuration associated with a data message, wherein the downlink control information message schedules the data message.

Aspect 22: The method of any of aspects 1 through 21, further comprising: determining a quantity of repetitions for transmission of the uplink message based at least in part on a downlink signal strength, a transmit power limit associated with the UE, or both.

Aspect 23: The method of aspect 22, wherein determining the quantity of repetitions based at least in part on the downlink signal strength further comprises: determining the quantity of repetitions for transmission of the uplink message based at least in part on the downlink signal strength satisfying one or more signal strength thresholds.

Aspect 24: The method of any of aspects 22 through 23, further comprising: selecting one or more resource for transmission of the uplink message from a set of resources associated with the uplink message based at least in part on determining the quantity of repetitions for transmission of the uplink message.

Aspect 25: The method of any of aspects 1 through 24, further comprising: receiving a system information block message indicating a configuration associated with the downlink control information message, wherein the configuration is active for a first NB IoT carrier associated with the UE.

Aspect 26: The method of any of aspects 1 through 25, further comprising: receiving a group-common downlink control information message comprising an indication of a backoff period, wherein the uplink message is transmitted via a time occasion selected from a set of time occasions in accordance with the backoff period.

Aspect 27: The method of aspect 26, wherein the indication of the backoff period comprises an indication of a time period or an indication of a quantity of transmission occasions.

Aspect 28: The method of any of aspects 1 through 27, further comprising: receiving a configuration indicating a limit transport block size; and selecting a transport block size from a set of candidate transport block sizes for transmission of the uplink message in accordance with the limit transport block size.

Aspect 29: A method for wireless communication by a network entity, comprising: receiving, based at least in part on an idle mode of a UE, an uplink message that contains user data at the UE, the uplink message comprising, via a set of bits, a first identifier associated with the UE; and transmitting a downlink control information message responsive to the uplink message, at least a portion of the downlink control information message scrambled according to a RNTI, wherein the RNTI is one of a plurality of RNTIs, the plurality of RNTIs including a first RNTI that is associated with contention resolution and the first identifier.

Aspect 30: The method of aspect 29, wherein the RNTI is the first RNTI, and the first RNTI comprises a first subset of the set of bits of the first identifier.

Aspect 31: The method of aspect 30, wherein a payload of the downlink control information message includes a second subset of the set of bits associated with the first identifier.

Aspect 32: The method of aspect 31, wherein resolving a contention between the UE and at least a second UE is based at least in part on the first RNTI and the payload of the downlink control information message.

Aspect 33: The method of any of aspects 30 through 32, wherein the uplink message is a contention-based shared PUR request message or an EDT request message, and the downlink control information message is at least in part for contention resolution.

Aspect 34: The method of any of aspects 29 or 33, wherein the RNTI is a second RNTI of the plurality of RNTIs.

Aspect 35: The method of aspect 34, wherein the second RNTI is a static RNTI.

Aspect 36: The method of any of aspects 34 through 35, wherein the downlink control information message schedules an uplink data transmission, a downlink data message, indicates the UE to perform a random access procedure for transmission of the user data, or a combination thereof.

Aspect 37: The method of aspect 36, wherein the uplink data transmission is scheduled for a retransmission, by the UE, of the user data, the downlink data message indicates the UE to switch to operating in a connected mode, or both.

Aspect 38: The method of any of aspects 34 through 37, wherein when the uplink message is a contention-based shared PUR request message, the second RNTI is based at least in part on time and frequency resources associated with the uplink message, a multiplexing signature associated with the UE, a demodulation reference signal sequence, or a combination thereof.

Aspect 39: The method of any of aspects 34 through 38, wherein when the uplink message is an EDT request message, the second RNTI is a temporary cell radio network temporary identifier associated with the UE.

Aspect 40: The method of any of aspects 29 through 39, wherein a size of the downlink control information message is different from a size of a second downlink control information message, where the downlink control information message is associated with a first downlink control information format that is different from a second downlink control information format associated with the second downlink control information message.

Aspect 41: The method of any of aspects 29 through 40, wherein a scrambling procedure associated with coded bits of the downlink control information message is different from a scrambling procedure of a second downlink control information message, where the downlink control information message is associated with a first downlink control information format that is different from a second downlink control information format associated with the second downlink control information message.

Aspect 42: The method of any of aspects 29 through 41, wherein the downlink control information message comprises a flag bit that indicates whether the downlink control information message is associated with a contention resolution procedure.

Aspect 43: The method of aspect 42, wherein the downlink control information message comprises one or more additional flag bits that indicate whether the downlink control information message is scheduling an uplink data message, whether the downlink control information message is scheduling a downlink data message, or both.

Aspect 44: The method of any of aspects 29 through 43, further comprising: transmitting a system information block message indicating a downlink control configuration, the downlink control configuration indicating at least one of a start occasion for a search space associated with the downlink control information message, a start offset for a search space associated with the downlink control information message, or a quantity of repetitions associated with the downlink control information message.

Aspect 45: The method of any of aspects 29 through 44, further comprising: transmitting a system information block message indicating an uplink control configuration, the uplink control configuration indicating the UE to transmit an acknowledgement message in response to the downlink control information message or in response to a downlink data message scheduled by the downlink control information message.

Aspect 46: The method of any of aspects 29 through 45, further comprising: transmitting a system information block message indicating a downlink data message configuration associated with a data message, wherein the downlink control information message schedules the data message.

Aspect 47: The method of any of aspects 29 through 46, further comprising: transmitting a system information block message indicating a configuration associated with the downlink control information message, wherein the configuration is active for a first NB IoT carrier associated with the UE.

Aspect 48: The method of any of aspects 29 through 47, further comprising: transmitting a group-common downlink control information message comprising an indication of a backoff period, wherein the uplink message is transmitted via a time occasion selected from a set of time occasions in accordance with the backoff period.

Aspect 49: The method of aspect 48, wherein the indication of the backoff period comprises an indication of a time period or an indication of a quantity of transmission occasions.

Aspect 50: The method of any of aspects 29 through 49, further comprising: transmitting a configuration indicating a limit transport block size, wherein the uplink message is transmitted using a transport block size from a set of candidate transport block sizes in accordance with the limit transport block size.

Aspect 51: A UE for wireless communication, comprising one or more memories storing processor-executable code, and one or more processors coupled with the one or more memories and individually or collectively operable to execute the code to cause the UE to perform a method of any of aspects 1 through 28.

Aspect 52: A UE for wireless communication, comprising at least one means for performing a method of any of aspects 1 through 28.

Aspect 53: A non-transitory computer-readable medium storing code for wireless communication, the code comprising instructions executable by one or more processors to perform a method of any of aspects 1 through 28.

Aspect 54: A network entity for wireless communication, comprising one or more memories storing processor-executable code, and one or more processors coupled with the one or more memories and individually or collectively operable to execute the code to cause the network entity to perform a method of any of aspects 29 through 50.

Aspect 55: A network entity for wireless communication, comprising at least one means for performing a method of any of aspects 29 through 50.

Aspect 56: A non-transitory computer-readable medium storing code for wireless communication, the code comprising instructions executable by one or more processors to perform a method of any of aspects 29 through 50.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable (e.g., processor-readable, processor-executable) medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, based at least in part on an idle mode of the UE, an uplink message that contains user data at the UE, the uplink message comprising, via a set of bits, a first identifier associated with the UE; and
receive a downlink control information message responsive to the uplink message, at least a portion of the downlink control information message scrambled according to a radio network temporary identifier (RNTI), wherein the RNTI is one of a plurality of RNTIs, the plurality of RNTIs including a first RNTI that is associated with contention resolution and the first identifier.

2. The UE of claim 1, wherein the one or more processors are individually or collectively further operable to execute the code to cause the UE to:
decode the downlink control information message based at least in part on the RNTI, wherein the RNTI is the first RNTI, and wherein the first RNTI is a UE-specific RNTI that comprises a first subset of the set of bits associated with the first identifier.

3. The UE of claim 2, wherein a payload of the downlink control information message includes a second subset of the set of bits associated with the first identifier.

4. The UE of claim 3, wherein resolving a contention between the UE and at least a second UE is based at least in part on at least one of the first RNTI and the payload of the downlink control information message.

5. The UE of claim 2, wherein the uplink message is a contention-based shared preconfigured uplink resources (PUR) request message or an early data transmission (EDT) request message, and wherein the downlink control information message is at least in part for contention resolution.

6. The UE of claim 1, wherein the one or more processors are individually or collectively further operable to execute the code to cause the UE to:
decode the downlink control information message based at least in part on the RNTI, wherein the RNTI is a second RNTI of the plurality of RNTIs different from the first RNTI, wherein the downlink control information message is associated with an uplink transmission, a downlink data message, an indication for the UE to perform a random access procedure for transmission of the user data, or a combination thereof.

7. The UE of claim 6, wherein the one or more processors are individually or collectively further operable to execute the code to cause the UE to:
decode the downlink control information message by evaluating, in a search space, a first scrambling hypothesis associated with the first identifier and by evaluating, in the search space, a second scrambling hypothesis associated with the second RNTI.

8. The UE of claim 6, wherein when the uplink message is a contention-based shared PUR request message, and wherein the second RNTI is based at least in part on time and frequency resources associated with the uplink message, a multiplexing signature associated with the UE, a demodulation reference signal sequence, or a combination thereof.

9. The UE of claim 6, wherein when the uplink message is an early data transmission (EDT) request message, and wherein the second RNTI is a temporary cell radio network temporary identifier associated with the UE.

10. The UE of claim 1, wherein a size of the downlink control information message is different from a size of a second downlink control information message, wherein the downlink control information message is associated with a first downlink control information format that is different from a second downlink control information format associated with the second downlink control information message.

11. The UE of claim 1, wherein a scrambling procedure associated with coded bits of the downlink control information message is different from a scrambling procedure of a second downlink control information message, wherein the downlink control information message is associated with a first downlink control information format that is different from a second downlink control information format associated with the second downlink control information message.

12. The UE of claim 1, wherein the downlink control information message comprises one or more flag bits that indicate whether the downlink control information message is associated with a contention resolution procedure, whether the downlink control information message is scheduling an uplink message, whether the downlink control information message is scheduling a downlink data message, or a combination thereof.

13. The UE of claim 1, wherein the one or more processors are individually or collectively further operable to execute the code to cause the UE to:
receive a system information block message indicating a downlink control configuration, the downlink control configuration indicating at least one of a start occasion for a search space associated with the downlink control information message, a start offset for a search space associated with the downlink control information message, or a quantity of repetitions associated with the downlink control information message.

14. The UE of claim 1, wherein the one or more processors are individually or collectively further operable to execute the code to cause the UE to:
receive a system information block message indicating an uplink control configuration, the uplink control configuration indicating the UE to transmit an acknowledgment message in response to the downlink control information message or in response to a downlink data message scheduled by the downlink control information message.

15. The UE of claim 1, wherein the one or more processors are individually or collectively further operable to execute the code to cause the UE to:
receive a system information block message indicating a downlink data message configuration associated with a data message, wherein the downlink control information message schedules the data message.

16. The UE of claim 1, wherein the one or more processors are individually or collectively further operable to execute the code to cause the UE to:
determine a quantity of repetitions for transmission of the uplink message based at least in part on a downlink signal strength, a transmit power limit associated with the UE, or both.

17. The UE of claim 1, wherein the one or more processors are individually or collectively further operable to execute the code to cause the UE to:
receive a system information block message indicating a configuration associated with the downlink control information message, wherein the configuration is active for a first NB-IoT carrier associated with the UE.

18. The UE of claim 1, wherein the one or more processors are individually or collectively further operable to execute the code to cause the UE to:
receive a group-common downlink control information message comprising an indication of a backoff period, wherein the uplink message is transmitted via a time occasion selected from a set of time occasions in accordance with the backoff period.

19. The UE of claim 1, wherein the one or more processors are individually or collectively further operable to execute the code to cause the UE to:
receive a configuration indicating a limit transport block size; and
select a transport block size from a set of candidate transport block sizes for transmission of the uplink message in accordance with the limit transport block size.

20. A method for wireless communication by a user equipment (UE), comprising:
transmitting, based at least in part on an idle mode of the UE, an uplink message that contains user data at the UE, the uplink message comprising, via a set of bits, a first identifier associated with the UE; and
receiving a downlink control information message responsive to the uplink message, at least a portion of the downlink control information message scrambled according to a first radio network temporary identifier (RNTI), wherein the RNTI is one of a plurality of RNTIs, the plurality of RNTIs including a first RNTI that is associated with contention resolution and the first identifier.
